(19) United States
(12) Patent Application Publication
(10) Pub. No.: US 2021/0222649 A1
(43) Pub. Date: Jul. 22, 2021

(54) ANNULAR EXHAUST NOZZLE

(71) Applicant: Garett Williams, Stone Mountain, GA (US)

(72) Inventor: Garett Williams, Stone Mountain, GA (US)

(21) Appl. No.: 17/100,877

(22) Filed: Nov. 21, 2020

Related U.S. Application Data
(60) Provisional application No. 62/938,763, filed on Nov. 21, 2019.

(51) Int. Cl. F02K 1/80

(52) U.S. Cl. CPC F02K 1/80; F05D 2240/128; F05D 2220/323

(57) ABSTRACT

An annular exhaust nozzle is disclosed designed to accept and redirect jet engine exhaust thereby generating direct reactive thrust as well as thrust via induction.

### BACKGROUND

The invention relates to propulsion devices for subsonic fuel-efficient vertical take off and landing aerial vehicles that mitigate risk of injury due to exposed propeller blades or hot jet engine efflux.

Similar inventions include propeller engines, which are used in helicopters and quadrotor vehicles. These feature exposed blades that can injure the passenger and/or others in the immediate vicinity. Similar inventions also include Jet Engines which are used in similar applications such as the Flyboard and the Jetpack. The disadvantage of these vehicles is that they cannot fly for very long due to rate of fuel consumption.

### SUMMARY OF PREFERRED EMBODIMENTS

It is an objective of the invention to create a high thrust high efficiency vertical take-off and landing engine for small personal aircraft (1-8 passengers) that does not feature exposed blades or hot engine efflux.

It is an objective of the invention to create a semi-conical wing that produces lift in conjunction with the turbofan engine via induction. The turbofan engine is a propulsion system, commonly used on commercial aircraft, which uses jet engine efflux to drive large fan blades and create thrust. The main components of the turbofan engine consists of an axial air compressor, a combustion system, two independent turbine systems, and a ducted fan. The majority of the thrust is not produced by the jet engine efflux but by the fan that it drives.

The embodiments herein feature an annular exhaust nozzle the inlet of which is fastened to the outlet of the engine cowling. Air flows into the annular ring and then out of an opening in the ring which is oriented 90° from the outlet of the engine cowling. The profile of the ring is an airfoil shape. The airfoil ring profile may be used to create additional lift for the engine

The annular exhaust nozzle is used to reorient a jet engine's thrust vector by forcing the airflow in another direction. The invention features an annular airflow jetting that is reinforced to withstand and re-orient exhaust generated by a turbofan engine.

The applications for such an annular exhaust nozzle can include retrofitting to turboshaft-powered rotary-wing aircraft.

### DETAILED DESCRIPTION OF THE DRAWINGS

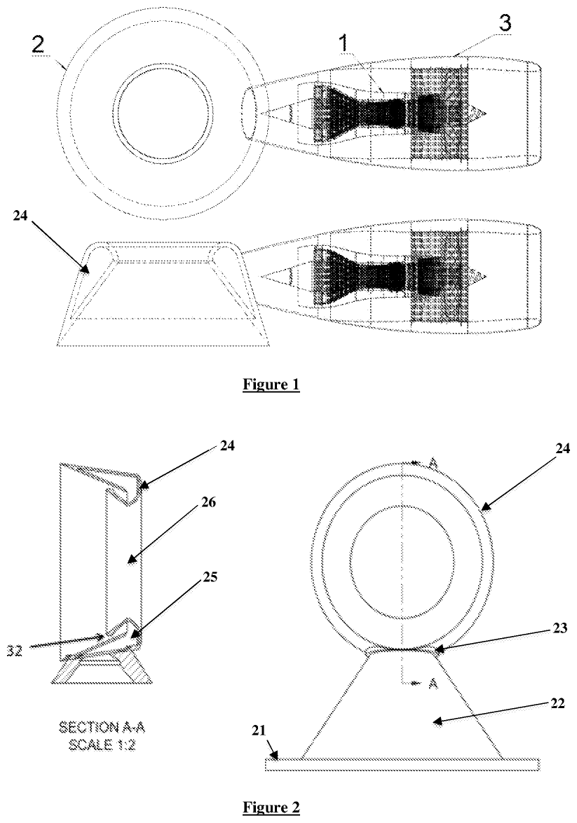

FIG. 1 shows one embodiment featuring a bladeless annular turbofan exhaust duct.

FIG. 2 shows a section view of the annular nozzle assembly.

### DETAILED DESCRIPTION OF PREFERRED EMBODIMENTS

The invention is described in preferred embodiments in the following description with reference to the Figs., in which like numbers represent the same or similar elements. Reference throughout this specification to “one embodiment”, “an embodiment”, or similar language means that particular feature, structure, or characteristic described in connection with the embodiment is included in at least one embodiment of the present invention. Thus, appearances of the phrases “in one embodiment”, “in an embodiment”, “in certain embodiments”, and similar language throughout this specification may, but do not necessarily, all refer to the same embodiment. It is noted that, as used in this description, the singular forms “a”, “an”, and “the” include plural referents unless the context clearly dictates otherwise.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

FIG. 1 presents one embodiment of the invention. Turbofan engine 1 is contained in engine cowling 3, the rear end of which is attached to the annular exhaust nozzle 2. Turbofan engine 1 delivers high velocity airflow at the exhaust cowling 31, which is connected to an adapter 21. Adapter 21 in one embodiment is a flanged assembly which bolts onto exhaust cowling 31. A duct 22 that abuts adapter 21 receives all of the exhaust from turbofan engine 1. In the embodiment shown in FIG. 2, the duct is conical, i.e. in the form of a converging nozzle. In other embodiments, it may be desirable to use a converging diverging nozzle or even a diverging nozzle for duct 22. A turbofan is characterized by having two distinct airflows, namely, bypass, or “cold” flow which is ducted around the combustion chamber, and “hot” flow which passes through the combustion chamber. Accordingly, in certain embodiments, the adapter-duct assembly may be designed to accept only the bypass or “cold” flow from the turbofan engine. One such embodiment would feature an annular inlet through the adapter-duct assembly to capture bypass exhaust airflow, while hot flow exhaust would pass through the center of the annular inlet.

Duct 22 is connected to annular exhaust assembly 24 via a mounting ring 23. In certain embodiments, mounting ring 23 is capable of rotation and is mounted on a bearing assembly. In these embodiments, actuating arms can be attached to the annular exhaust assembly 24, or mounting ring 23 can be motorized to allow the annual exhaust assembly 24 to be rotated.

An embodiment of annular exhaust assembly 24 is shown in cross section in FIG. 2. It consists of a plenum 22 that is in fluid communication with duct 22, and which is designed to receive exhaust gas flow from turbofan engine 1. Annular exhaust 32 is formed from the lower part of the plenum and from the wall of the central portion of annular exhaust assembly 24. Exhaust gas flow from turbofan engine 1 passes through the plenum and out the annular exhaust 32. In certain embodiments, annular exhaust 32 may contain airfoil shaped louvers to optimize the aerodynamic efficiency of the exhaust gas flow through annular exhaust 32. As the exhaust gas passes out of the annular exhaust 32, it tends to create a low pressure region inducing downward airflow through in the center of the annular exhaust assembly 24 due to the Venturi effect. This has the effect of enhancing the lifting force created by the downward-flowing exhaust gas through annular exhaust 32.

The annular exhaust nozzle 2 in one embodiment is fabricated primarily from carbon-reinforced fiber polymer using vacuum deposition.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

I claim:

1. A annular exhaust nozzle, comprising:
An adapter comprising:
a first end adapted to be attached to the exhaust portion of, and which receives at least a portion of exhaust gases flowing from a jet engine;
a mounting ring; and
a duct disposed between, and connecting the first end and the mounting ring′
An annular exhaust assembly jointed by the mounting ring to the adapter, comprising:
a plenum in fluid communication with the intake manifold having an upper portion and a lower portion;
wherein the lower portion contains an opening configured to direct the exhaust gases in such a way as to create a reactive lifting force as well as generate inductive thrust through the center portion of the annular exhaust assembly.

2. The annular exhaust nozzle of claim 1, wherein the annular exhaust assembly is fabricated primarily from carbon-reinforced fiber polymer.
